(19) United States
(12) Patent Application Publication
(10) Pub. No.: US 2006/0232180 A1
(43) Pub. Date: Oct. 19, 2006

(54) Field emission backlight unit, method of driving the same, and method of manufacturing lower panel

(76) Inventors: Ho-Suk Kang, Seoul (KR); Byong-Gwon Song, Seoul (KR); Deuk-Seok Chung, Seongnam-si (KR); Jun-Hee Choi, Seongnam-si (KR); Ha-Jong Kim, Seongnam-si (KR)

Correspondence Address: Robert E. Bushnell;Suite 300, 1522 K Street, N.W., Washington, DC, 20005-1202, US

(21) Appl. No.: 11/405,014

(22) Filed: Apr. 17, 2006

(30) Foreign Application Priority Data
Apr. 15, 2005 (KR) 10-2005-0031558

(51) Int. Cl. H01J 19/10; H01J 1/00

(52) U.S. Cl. 313/336; 313/495; 313/496; 313/306; 313/311; 313/310

(57) ABSTRACT

In a field emission backlight unit, a method of driving the same, and a method of manufacturing a lower substrate, the field emission backlight unit includes: a lower substrate; first and second electrodes alternately formed in parallel lines on the lower substrate; emitters interposed between the lower substrate and the first electrodes; an upper substrate spaced a predetermined distance from the lower substrate and facing the lower substrate; a third electrode formed on a bottom surface of the upper substrate; and a phosphor layer formed on the third electrode. The driving method comprises applying a cathode voltage to the first electrodes and a gate voltage to the second electrodes, followed by reversing the application of the voltages to the first and second electrodes. The manufacturing method comprises forming and drying or firing a patterned carbon nanotube (CNT) layer, and then pattering, drying and firing a conductive thick film.

### CLAIM OF PRIORITY

This application makes reference to, incorporates the same herein, and claims all benefits accruing under 35 U.S.C. §119 from an application for FIELD EMISSION TYPE BACKLIGHT UNIT, DRIVING METHOD THEREOF AND MANUFACTURING METHOD OF LOWER PANEL earlier filed in the Korean Intellectual Property Office on the 15^{th} of Apr. 2005 and there duly assigned Serial No. 10-2005-0031558.

### BACKGROUND OF THE INVENTION

1. Technical Field

The present invention relates to a backlight unit for a liquid crystal display (LCD) and, more particularly, to a field emission backlight unit, a method of driving the same, and a method of manufacturing a lower panel of a field emission backlight unit.

2. Related Art

In general, flat panel displays are largely classified into light emitting displays and light receiving displays. Light emitting flat panel displays include cathode ray tubes (CRTs), plasma display panels (PDPs), and field emission displays (FEDs), while light receiving flat panel displays include liquid crystal displays (LCDs). Among these flat panel displays, LCDs have advantages of being lightweight and having low power consumption, but have a disadvantage in that, since they form an image not by emitting light themselves but by receiving light from an outside source, the image cannot be viewed in a dark place. To solve this problem, a backlight unit for emitting light is installed at a rear surface of the LCD so that the LCD can form an image in a dark place.

A conventional backlight unit uses linear or point light sources. Typically, a cold cathode fluorescent lamp (CCFL) is used as a linear light source, and a light emitting diode (LED) is used as a point light source. However, the conventional backlight unit is disadvantageous in that, since its structure is complex, manufacturing costs are high, and since the light source is disposed at the side of the backlight unit, power consumption is high when light is reflected and transmitted. In particular, as the size of the LCD increases, it becomes more difficult to achieve uniform brightness with a conventional backlight unit.

Accordingly, in recent years, a field emission backlight unit having a planar light-emitting structure has been suggested. The field emission backlight unit has lower power consumption and more uniform brightness over a larger area than a backlight unit using a typical CCFL.

Korean Patent Publication No. 2002-33948 discloses that an indium tin oxide (ITO) electrode layer and a phosphor layer are sequentially stacked on the bottom surface of an upper substrate. A thin metal layer and a carbon nanotube (CNT) layer are sequentially stacked on the top surface of a lower substrate. The upper substrate and the lower substrate are bonded to each other with a spacer therebetween. A glass tube for vacuum ventilation is installed in the lower substrate.

If a voltage is applied between the ITO electrode layer and the thin metal layer, electrons are emitted from the CNT layer and impact against the phosphor layer. As a result, fluorescent materials in the phosphor layer become excited and emit visible light.

However, the conventional field emission backlight unit has a diode-type field emission structure in which the ITO electrode layer disposed on the upper substrate is used as an anode and the thin metal layer disposed on the lower substrate is used as a cathode. Since a high voltage used for emitting electrons is directly applied between the anode and the cathode, this diode-type structure is vulnerable to local arcing. If such local arcing occurs, brightness cannot be maintained uniform over the entire surface of the backlight unit, and the ITO electrode layer, the phosphor layer, and the CNT layer gradually become damaged, thereby reducing the lifespan of the backlight unit.

### SUMMARY OF THE INVENTION

The present invention provides a field emission backlight unit with improved anode field shielding performance, brightness uniformity, and lifespan.

The present invention also provides a method of driving the field emission backlight unit.

The present invention further provides a method of manufacturing the field emission backlight unit through a simple manufacturing process and at low manufacturing cost.

According to an aspect of the present invention, a field emission backlight unit comprises: a lower substrate; first and second electrodes alternately formed in parallel lines on the lower substrate; emitters interposed between the lower substrate and the first electrodes; an upper substrate spaced a predetermined distance from the lower substrate and facing the lower substrate; a third electrode formed on a bottom surface of the upper substrate; and a phosphor layer formed on the third electrode.

The emitters may be made of carbon nanotubes (CNTs). The first and second electrodes may be conductive thick films.

The first electrodes and the second electrodes may alternately act as cathodes and gate electrodes, and the third electrode may act as an anode.

In this case, the emitters may be arranged at predetermined intervals along both edges of the first electrodes. A plurality of emitter grooves may be formed at predetermined intervals along both edges of the first and second electrodes, and the emitters may be partially exposed by the plurality of emitter grooves.

The emitters may be arranged in parallel lines along both edges of the first electrodes. In this case, the emitter grooves may not be formed, and the emitters may be formed on bottom surfaces of the first electrodes in simple straight lines along both the edges of the first electrodes.

The first electrodes and the second electrodes may alternately act as cathodes and gate electrodes, and the third electrode may act as an anode.

In this case, the emitters may be arranged at predetermined intervals along both edges of the first and second electrodes. The emitters disposed on the first electrodes and the emitters disposed on the second electrodes may be arranged by turns. A plurality of emitter grooves may be formed at predetermined intervals along both edges of the first and second electrodes, and the emitters may be partially exposed by the plurality of emitter grooves.

According to another aspect of the present invention, a method of driving a triode-type field emission backlight unit, which includes a lower substrate on which first electrodes, second electrodes and emitters disposed between the first and second electrodes and the lower substrate are formed, and an upper substrate on which a third electrode is formed, comprises: applying a cathode voltage to the first electrodes, a gate voltage to the second electrodes, and an anode voltage to the third electrode so as to emit electrons from the emitters disposed below the first electrodes; applying a gate voltage to the first electrodes, a cathode voltage to the second electrodes, and an anode voltage to the third electrode so as to emit electrons from the emitters disposed below the second electrodes; and repeating the above steps.

According to still another aspect of the present invention, a method of manufacturing a lower panel of a field emission backlight unit comprises: forming a patterned CNT layer on a transparent substrate using a screen-printing method; drying or firing the CNT layer; patterning a conductive thick film in a plurality of parallel lines so as to form alternating first and second electrodes using a screen-printing method so that the CNT layer are partially covered by both edges of at least the first electrodes; and drying and firing the conductive thick film.

The CNT layer may be formed in a plurality of parallel lines, or a plurality of lines that are longitudinally arranged at predetermined intervals.

Emitter grooves may be formed along both edges of the first electrodes, and the patterned CNT layer may be partially covered by the emitter grooves.

Emitter grooves may be formed along both edges of the first and second electrodes, and the patterned CNT layer may be partially covered by the emitter grooves.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a cross-section view of a field emission backlight unit;

FIG. 2 is a partial cross-section view of a field emission backlight unit according to an embodiment of the present invention;

FIG. 3 is a partial perspective view of a lower panel of the backlight unit of FIG. 2;

FIG. 4 is a partial cross-section view of a modified example of the field emission backlight unit of FIG. 2;

FIG. 5 is a partial perspective view of a lower panel of the backlight unit of FIG. 4;

FIG. 6 is a partial cross-section perspective view of a field emission backlight unit according to another embodiment of the present invention;

FIG. 7 is a partial perspective view of a lower panel of the backlight unit of FIG. 6;

FIG. 8 is a plan view of the lower panel of the backlight unit of FIG. 6 for explaining a method of driving the backlight unit; and

FIGS. 9 thru 11 are photographs illustrating an upper portion and a section of the lower panel taken by a scanning electron microscope (SEM).

### DETAILED DESCRIPTION OF THE INVENTION

The present invention will now be described more fully with reference to the accompanying drawings, in which exemplary embodiments of the invention are shown. Like reference numerals denote like elements throughout the drawings.

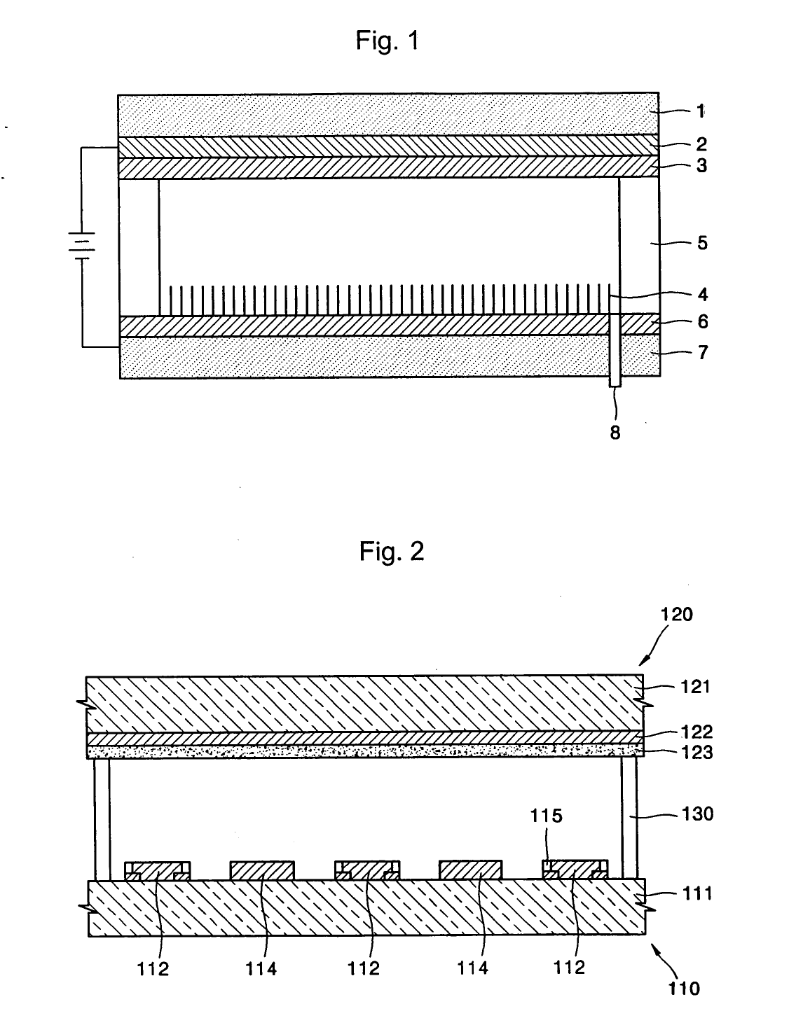

FIG. 1 is a cross-section view of a field emission backlight unit. Referring to FIG. 1, an indium tin oxide (ITO) electrode layer 2 and a phosphor layer 3 are sequentially stacked on the bottom surface of an upper substrate 1. A thin metal layer 6 and a carbon nanotube (CNT) layer 4 are sequentially stacked on the top surface of a lower substrate 7. The upper substrate 1 and the lower substrate 7 are bonded to each other with a spacer 5 therebetween. A glass tube 8 for vacuum ventilation is installed in the lower substrate 7.

If a voltage is applied between the ITO electrode layer 2 and the thin metal layer 6, electrons are emitted from the CNT layer 4 and impact against the phosphor layer 3. As a result, fluorescent materials in the phosphor layer 3 become excited and emit visible light.

However, the field emission backlight unit has a diode-type field emission structure in which the ITO electrode layer 2 disposed on the upper substrate 1 is used as an anode and the thin metal layer 6 disposed on the lower substrate 7 is used as a cathode. Since a high voltage used for emitting electrons is directly applied between the anode and the cathode, this diode-type structure is vulnerable to local arcing. If such local arcing occurs, brightness cannot be maintained uniform over the entire surface of the backlight unit, and the ITO electrode layer 2, the phosphor layer 3, and the CNT layer 4 gradually become damaged, thereby reducing the lifespan of the backlight unit.

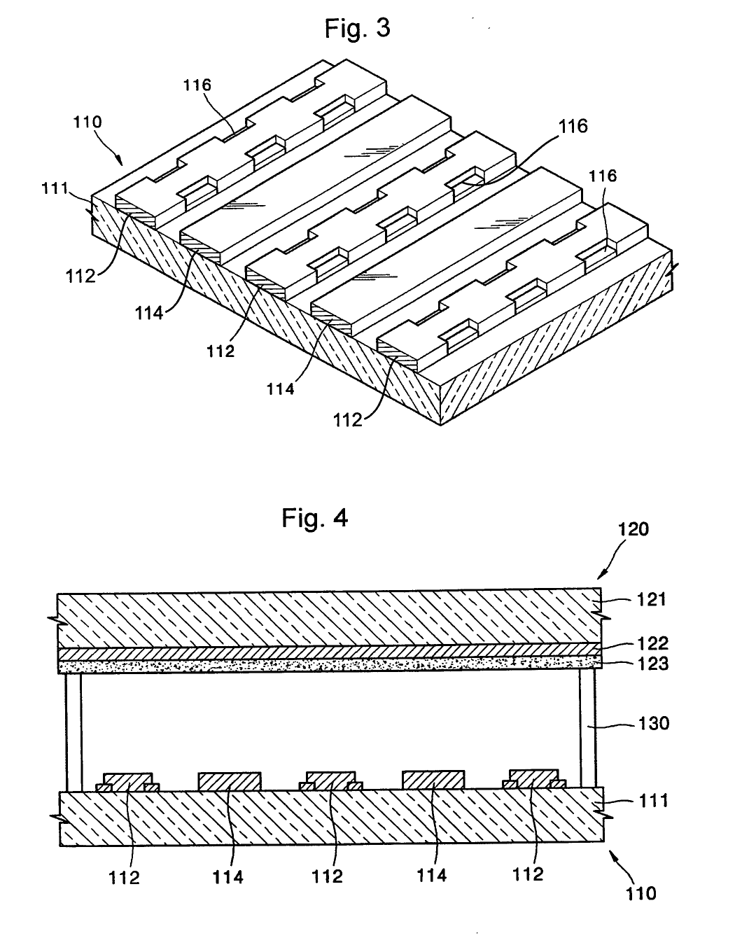

FIG. 2 is a partial cross-section view of a field emission backlight unit according to an embodiment of the present invention, and FIG. 3 is a partial perspective view of a lower panel of the backlight unit of FIG. 2.

Referring to FIGS. 2 and 3, the field emission backlight unit includes a lower panel 110 and an upper panel 120, which are spaced a predetermined distance from each other and which face each other. The lower panel 110 and the upper panel 120 are constructed so as to be suitable for triode-type field emission.

In detail, the lower panel 110 includes a transparent lower substrate 111 which may be made of glass, first electrodes 112 and second electrodes 114 which are formed on the lower substrate 111 and act as cathodes and gate electrodes, respectively, and carbon nanotube (CNT) emitters 116 which are disposed below the first electrodes 112 and which are shorter than the first electrodes 112.

The upper panel 120 includes a transparent upper substrate 121 which may be made of glass, a third electrode 122 which is formed on a bottom surface of the upper substrate 121 and acts as an anode, and a phosphor layer 123 which is formed on the third electrode 122.

The lower panel 110 and the upper panel 120 are bonded to each other using a sealing material (not shown) coated along the perimeters thereof. A spacer 130 is installed between the lower panel 110 and the upper panel 120 so as to maintain the predetermined distance between the lower panel 110 and upper panel 120.

To be more specific, the first electrodes 112 are arranged in parallel lines on a top surface of the lower substrate 111 of the lower panel 110 so as to serve as cathodes, and the second electrodes 114 are arranged in parallel lines on the top surface of the lower substrate 111 of the lower panel 110 so as to serve as gate electrodes. The first electrodes 112 and the second electrodes 114 are alternately arranged on the same plane of the top surface of lower substrate 111.

The emitters 116 are interposed between the lower substrate 111 and the first electrodes 112 and/or between the lower substrate 111 and the second electrodes 114. The emitters 116 are interposed between the lower substrate 111 and the first electrodes 112 and second electrodes 114 along both edges of the first electrodes 112 and second electrodes 114 so that the emitters 116 partially overlap bottom surfaces of the first electrodes 112 and second electrodes 114. That is, the emitters 116 are partially covered by of the first electrodes 112 and second electrodes 114, and are partially exposed.

Accordingly, the first electrodes 112 and second electrodes 114 are higher than the emitters 116 so as to form thick structures. The first electrodes 112 and second electrodes 114 may be made of a conductive material, such as a paste, with a thickness of approximately 3 to 30 μm. If the first electrodes 112 and second electrodes 114 have a thickness of less than 3 μm, the emitters 116 cannot be sufficiently covered by the first electrodes 112 and second electrodes 114. If the first electrodes 112 and second electrodes 114 have a thickness of greater than 30 μm, it is difficult to activate the emitters 116 and to maintain the field emission structure.

As described above, after the emitters 116 are formed on the lower substrate 110, the first electrodes 112 and second electrodes 114 made of the same material are formed to the same height on the emitter 116. As will be described below with respect to a manufacturing method, the first electrodes 112 and second electrodes 114 can be simultaneously formed, thereby simplifying the manufacturing process and reducing manufacturing cost.

The emitters 116 partially formed on the bottom surfaces of the first electrodes 112, which act as cathodes, emit electrons as a result of an electric field formed by a voltage applied between the first electrodes 112 and second electrodes 114. The emitters 116 are made of CNTs. The CNTs can effectively emit electrons at a relatively low driving voltage. Furthermore, as will be described below with respect to the manufacturing process, when a CNT paste or a functional CNT is used, the CNT emitters 116 can be easily formed on a larger substrate, and, accordingly, a larger backlight unit can be manufactured. Moreover, since the first electrodes 112 and second electrodes 114 are formed as thick films (as opposed to thin films used in the conventional art), a larger backlight unit can be manufactured more easily and at lower cost.

In the present embodiment, the CNT emitters 116 are disposed below the first electrodes 112 at predetermined intervals along both the longitudinal edges of the first electrodes 112. In detail, emitter grooves 115 are formed at predetermined intervals along both longitudinal edges of the first electrodes 112, and the CNT emitters 116 are longitudinally arranged at predetermined intervals so that the CNT emitters 116 can be inserted into the emitter grooves 115. Next, the first electrodes 112 are placed on the CNT emitters 116 so that the CNT emitters 116 are partially exposed through the emitter grooves 115.

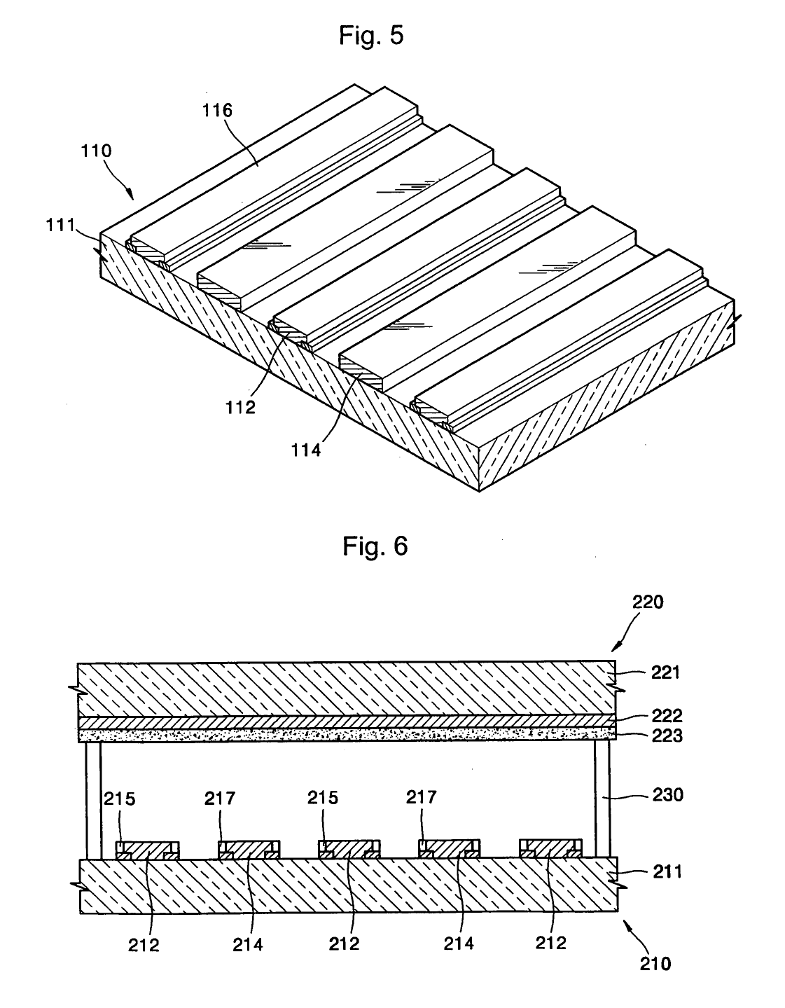

FIG. 4 is a partial cross-section view of a modified example of the field emission backlight unit of FIG. 2, and FIG. 5 is a partial perspective view of a lower panel of the backlight unit of FIG. 4. They illustrate a modified example of the lower panel 110 of the backlight unit of FIG. 2.

Referring to FIGS. 4 and 5, CNT emitters 116 are formed below the first electrodes 112 in parallel lines along both the edges of the first electrodes 112 and are thinner than the first electrodes 112. The first electrodes 112, placed on the CNT emitters 116′, are also formed in simple parallel lines, and the emitter grooves 115 are not included. Accordingly, the emitters 116′ are partially covered by the first electrodes 112 along both the sides of the first electrodes 112, and are partially exposed.

The emitters 116 and 116′ and the first electrodes 112 and second electrodes 114 can be manufactured simply and inexpensively by screen-printing a CNT paste or a conductive paste.

Referring back to FIGS. 2 and 3, the third electrode 122 formed on the bottom surface of the upper substrate 121 acts as an anode, and is made of a transparent conductive material, such as indium tin oxide (ITO), through which visible light emitted from the phosphor layer 123 can be transmitted. The third electrode 122 may be formed as a thin film on the entire bottom surface of the upper substrate 121, or it may be formed in a predetermined pattern, for example, a stripe pattern, on the bottom surface of the upper substrate 121.

The phosphor layer 123 is formed on a bottom surface of the third electrode 122, and is made of red (R), green (G) and blue (B) fluorescent materials. The R, G and B fluorescent materials may be individually coated on the bottom surface of the third electrode 122 in a predetermined pattern, or they may be mixed together and then coated on the entire bottom surface of the third electrode 122.

A method of driving the field emission backlight unit illustrated in FIG. 2 will now be explained.

If predetermined voltages are applied to the first electrodes 112, the second electrodes 114, and the third electrodes 122, respectively, an electric field is formed between the electrodes 112, 114 and 122 so as to emit electrons from the CNT emitters 116. In detail, a cathode voltage ranging from zero to tens of volts is applied to the first electrodes 112, a gate voltage ranging from a few to hundreds of volts is applied to the second electrodes 114, and an anode voltage ranging from hundreds to thousands of volts is applied to the third electrode 122. The electrons emitted from the emitters 116 form a beam and bombard the phosphor layer 123. Accordingly, the R, G and B fluorescent materials of the phosphor layer 123 are excited and emit white visible light.

As described above, since the field emission backlight unit has a triode-type field emission structure, it can perform more stable field emission than a conventional backlight unit having a diode-type field emission structure. In particular, since the emitters 116 are lower than the upper surfaces of the first electrodes 112 and/or the second electrodes 114, emitters 116 can be effectively an anode field resulting from the anode voltage of hundreds to thousands of volts applied to the third electrode 122, diode emission caused by the anode field can be suppressed, and efficient emission control for the gate electrodes can be achieved.

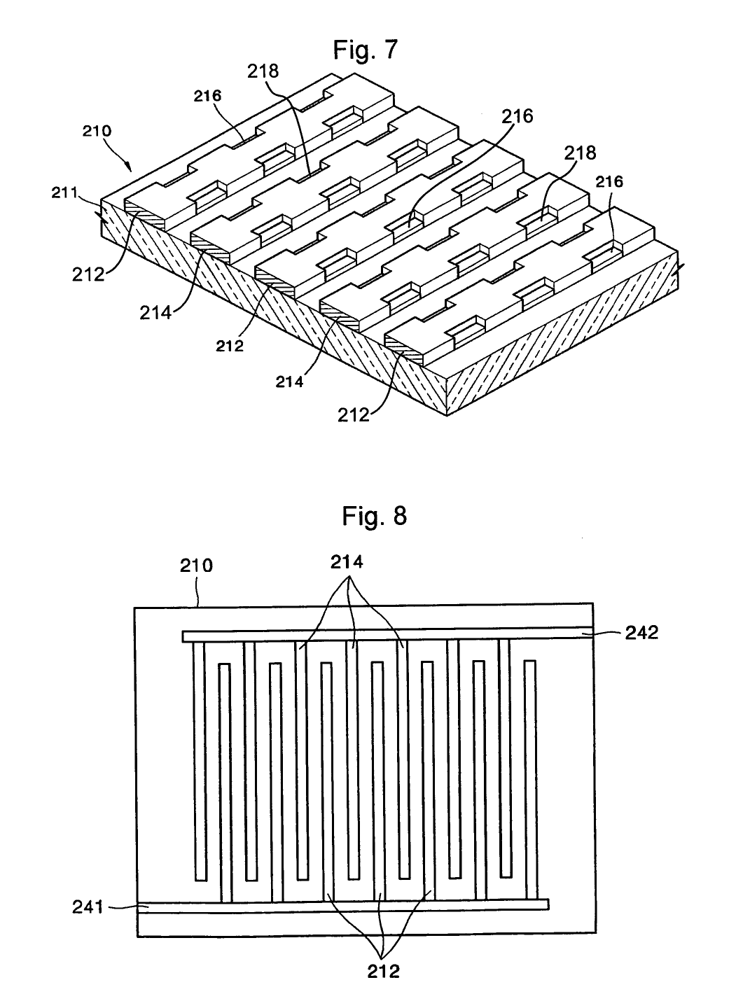

FIG. 6 is a partial cross-section view of a field emission backlight unit according to another embodiment of the present invention, and FIG. 7 is a partial perspective view of a lower panel of the backlight unit of FIG. 6.

Referring to FIGS. 6 and 7, the backlight unit includes a lower panel 210 and an upper panel 220, which are separated by a predetermined distance from each other by means of a spacer 230. The lower panel 210 includes a lower substrate 211, first electrodes 212 and second electrodes 214 formed on the lower substrate 211, and CNT emitters 216 and 218 which are disposed on the first electrodes 212 and second electrodes 214, respectively, and which are shorter than the first electrodes 212 and second electrodes 214, respectively.

The first electrodes 212 and second electrodes 214 illustrated in FIG. 6 are arranged with the same structure as the electrodes 112 and 114 illustrated in FIG. 2, and may be conductive thick films having a thickness of 3 to 30 μm.

However, the first electrodes 212 and second electrodes 214 alternately act as cathodes and gate electrodes. To this end, the CNT emitters 216 and 218 of FIG. 7 are formed partially below the first electrodes 212 and second electrodes 214, respectively. That is, the plurality of CNT emitters 216 and 218 are disposed on bottom surfaces of the first electrodes 212 and second electrodes 214, respectively, at predetermined intervals along both longitudinal edges of the first electrodes 212 and second electrodes 214, respectively. Emitter grooves 215 (FIG. 6) are formed along both the edges of the first electrodes 212 and second electrodes 214, respectively, and the CNT emitters 216 and 218 (FIG. 7) are partially exposed by the emitter grooves 215. Particularly, the CNT emitters 216 disposed below the first electrodes 212 and the CNT emitters 218 disposed below the second electrodes 214 may be alternately arranged so that the CNT emitters 216 formed below the first electrodes 212 face the second electrodes 214, and the CNT emitters 218 formed below the second electrodes 214 face the first electrodes 212. Accordingly, electrons can be more smoothly emitted from the CNT emitters 216 and 218.

The modified example of the lower panel of the backlight unit illustrated in FIGS. 4 and 5 can be applied to the embodiment illustrated in FIGS. 6 and 7.

The upper panel 220 includes an upper substrate 221, a third electrode 222 which is formed on a bottom surface of the upper substrate 221 and which acts as an anode, and a phosphor layer 223 formed on the third electrode 222. The detailed construction of the upper panel 220 is the same as that of the upper panel 120 illustrated in FIG. 2, and thus a detailed description thereof will not be given.

FIG. 8 is a plan view of the lower panel of the backlight unit of FIG. 6 for explaining a method of driving the backlight unit.

Referring to FIG. 8, the plurality of first electrodes 212 formed on the lower substrate 210 are connected to a first wire 241 through which a voltage is applied, and the plurality of second electrodes 214, alternating with the first electrodes 212, are connected to a second wire 242 through which a voltage is applied. The first electrodes 212 and second electrodes 214 alternately act as cathodes and gate electrodes, as described above.

In detail, if a cathode voltage of zero to several tens of volts is applied to the first electrodes 212 through the first wire 241, and a gate voltage of a few to hundreds of volts is applied to the second electrodes 214 through the second wire 24, while applying an anode voltage of hundreds to thousands of volts to the third electrode 222 formed on the upper substrate 221 illustrated in FIG. 6, the first electrodes 212 function as cathodes so that electrons are emitted from the CNT emitters 216 (FIG. 7) formed below the first electrodes 212. Next, if a gate voltage is applied to the first electrodes 212 through the first wire 241, and a cathode voltage is applied to the second electrodes 214 through the second wire 242, the second electrodes 214 function as cathodes so that electrons are emitted from the CNT emitters 218 (FIG. 7) formed below the second electrodes 214. By repeating these processes, electrons are alternately emitted from the CNT emitters 216 formed below the first electrodes 212 and from the CNT emitters 218 formed below the second electrodes 214. The emitted electrons form a beam and irradiate the phosphor layer 223 formed on the upper substrate 221 illustrated in FIG. 6. Accordingly, fluorescent materials of the phosphor layer 223 are excited and emit white visible light.

In the method of driving the backlight unit of FIG. 6, since electrons are alternately emitted from the CNT emitters 216 (FIG. 7) formed below the first electrodes 212 and from the CNT emitters 218 (FIG. 7) formed below the second electrodes 214, the lifespan of the CNT emitters 216 and 218 can be longer than the CNT emitters 116 of FIG. 3. That is, if a time interval between application of the gate voltage to the first electrodes 212 and application of the gate voltage to the second electrodes 214 is different from that in the embodiment of FIGS. 2 AND 3, the load applied to the CNT emitters 216 and 218 is reduced, and thus lifespan is prolonged, while obtaining the same brightness as in the embodiment of FIGS. 2 and 3. On the other hand, if the time interval between application of the gate voltage to the first electrodes 212 and application of the gate voltage to the second electrodes 214 is the same as in the embodiment of FIGS. 2 and 3, the lifespan of the CNT emitters 216 and 218 is the same as in the embodiment of FIGS. 2 and 3, but the number of electrons emitted within the same time is increased, and thus brightness is further improved.

Accordingly, the method of driving the backlight unit of FIG. 6 has an advantage in that the lifespan and brightness of the CNT emitters 216 and 218 (FIG. 7) can be adjusted by controlling the time interval between application of the gate voltage to the first electrodes 212 and application of the gate voltage to the second electrodes 214.

A method of manufacturing a lower panel of a backlight unit according to an embodiment of the present invention will now be explained.

As described above, the lower panels 110 and 210 of the backlight units illustrated in FIGS. 2, 3 and 6, 7 have similar structures, except that the CNT emitters 116 of FIG. 3 are formed only below the first electrodes 112, while the CNT emitters 216 and 218 of FIG. 7 are formed below the first electrodes 212 and second electrodes 214, respectively. Accordingly, the manufacturing method will be explained based on the lower panel 110 of the backlight unit of FIGS. 2 and 3 and, for the lower panel 210 of the backlight unit of FIGS. 6 and 7, only the difference will be explained.

The transparent lower substrate 111, for example, a glass substrate, having a predetermined thickness is prepared. The emitters 116 (FIG. 3) may be formed on the prepared lower substrate 111 by screen-printing a CNT paste or a functional CNT. Since the screen-printing method does not require a photoresist application, which is necessary in a conventional thin film manufacturing method, the manufacturing process can be simplified and manufacturing cost can be reduced. Particularly, since the conventional thin film manufacturing method requires an exposure process, the CNT paste must be only a photosensitive material. However, since the manufacturing method of the present embodiment does not require an exposure process, a non-photosensitive material can be used as the CNT paste. Furthermore, when a non-photosensitive material is used instead of a photosensitive material, degradation of the emitters 116 (FIG. 3) due to residual substances can be reduced, thereby increasing the lifespan of the emitters 116.

The emitters 116 may have, but are not limited to, a thickness of 1 to 3 μm. If the emitters 116 have a thickness of less than 1 μm, electron emission may be reduced. If the emitters 116 have a thickness of greater than 3 μm, it can be difficult to activate the emitters 116 and to maintain the field emission structure.

The emitters 116 may be patterned in a plurality of parallel lines, or in a plurality of lines which are longitudinally disposed at predetermined intervals.

After the screen-printing process, the CNT emitters 116 are hardened by drying or firing. To this end, the CNT emitters 116 may be thermally treated at a temperature of approximately 50 to 100° C. for approximately 5 minutes to 1 hour.

After the patterned emitters 116 are formed, the first electrodes 112 are formed on the patterned emitters 116. To this end, a patterned conductive material for the first electrodes 112 is screen-printed. The first electrodes 112 may have a thickness of 3 to 30 μm, and the conductive material may be a paste.

The shapes of the first electrodes 112 may vary depending on the patterns of the emitters 116. That is, when the emitters 116 are formed in simple lines, the first electrodes 112 are patterned in simple straight lines so that emitter grooves are not formed along edges of the first electrodes 112. In this case, the electrodes 112 partially overlap the emitters 116. That is, the emitters 116 are partially covered by the electrodes 112 and 114, and are partially exposed. In contrast, when the emitters 116 are formed in lines that are longitudinally arranged at predetermined intervals, the emitter grooves 115 are formed at predetermined intervals along both edges of the electrodes 112 so as to expose the emitters 116. When the emitters 116 are partially covered by the electrodes 112 so that the electrodes 112 are higher than the emitters 116, an anode field produced around the emitters 116 due to an anode voltage can be effectively shielded. In addition, the parts of the emitters 116 covered by the electrodes 112, that is, the parts of the emitters 116 not exposed by the emitter grooves 115, function as resistive layers, thereby improving brightness uniformity of the backlight unit.

After the conductive material for the first electrodes 112 is screen-printed, the resultant structure is dried and fired. The firing process may be performed at a low temperature of approximately 300 to 600° C. for 1 to 10 hours. By means of this firing process, organic matter and a binder can be removed.

The above manufacturing method has been explained based on the backlight unit of FIGS. 2 and 3. The backlight unit of FIGS. 6 and 7 is different from the backlight unit of FIGS. 2 and 3 in that the emitters 216 of FIG. 7 are formed below the first electrodes 212 of FIG. 6 and the emitters 218 of FIG. 7 are formed below the second electrodes 214 of FIG. 6. Accordingly, when the patterned emitters 216 are formed on the lower substrate 211, emitters 218 having the same shape as the emitters 216 are formed on the substrate 211 in a plurality of lines that are longitudinally arranged at predetermined intervals, and the emitter grooves 217 are formed in the second electrodes 214. The emitter grooves 217 in the second electrodes 214 and the emitter grooves 215 in the first electrodes 212 are arranged in an alternating fashion.

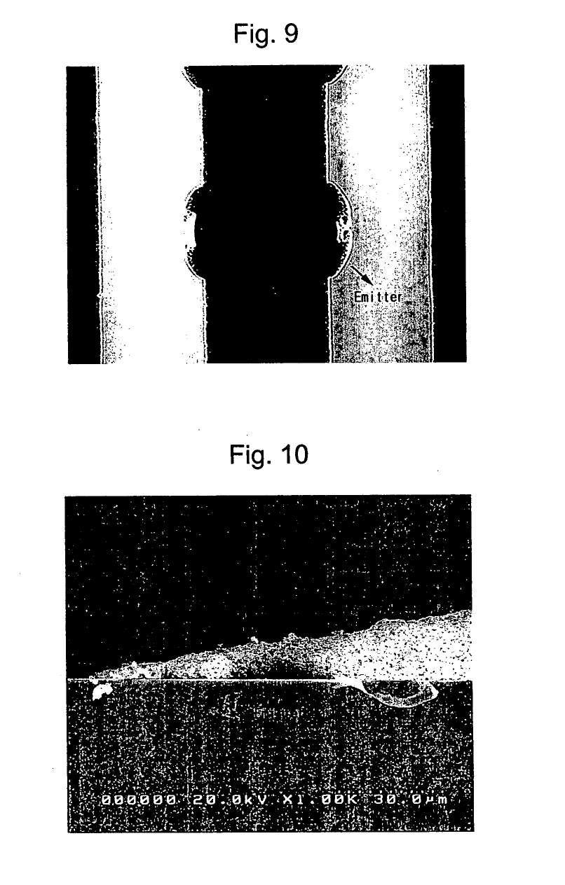

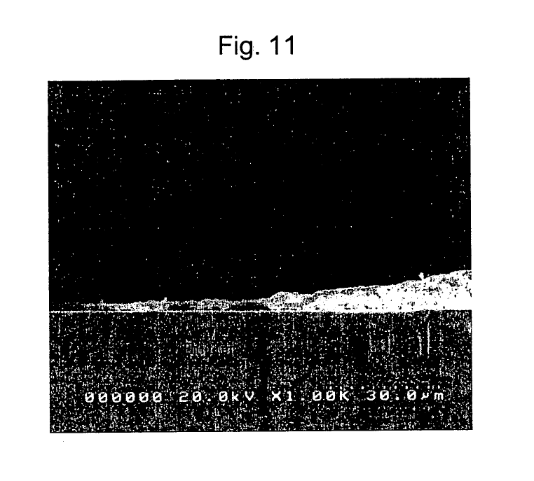

FIGS. 9 thru 11 are photographs illustrating an upper portion and a section of the lower panel 110 taken by a scanning electron microscope. In FIG. 9, which illustrates an upper end of the first electrodes 112, the emitters 116 are partially protruding from left and right sides of the electrodes 112. In FIGS. 10 and 11, which illustrate a section of the first electrodes 112, the emitters 116 are inserted in a concave portion below the first electrodes 112.

As described above, the lower panel of the backlight unit and the manufacturing method thereof according to the present invention make it possible to realize a large backlight unit using a thick film, and efficiently shield the emitters from an anode field produced by an anode voltage. The portions where the emitters and the electrodes overlap act as resistive layers, thereby improving brightness uniformity of the backlight unit. The backlight unit is manufactured using a simple screen-printing method without a complex process, such as a photolithography process or an exposure process, thereby reducing manufacturing cost. Since the backlight unit does not require a photoconductive material, degradation of the emitters and electrodes due to residual substances are reduced, thereby increasing the lifespan of the backlight unit.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A field emission backlight unit, comprising:
a lower substrate;
first and second electrodes alternately formed in parallel lines on the lower substrate;
emitters interposed between the lower substrate and the first electrodes;
an upper substrate spaced a predetermined distance from the lower substrate and facing the lower substrate;
a third electrode formed on a bottom surface of the upper substrate; and
a phosphor layer formed on the third electrode.

2. The field emission backlight unit of claim 1, wherein the emitters are made of carbon nanotubes (CNTs).

3. The field emission backlight unit of claim 1, wherein the first and second electrodes are conductive thick films.

4. The field emission backlight unit of claim 1, wherein each of the first and second electrodes has a thickness in a range of 3 to 30 μm.

5. The field emission backlight unit of claim 1, wherein each of the emitters has a thickness in a range of 1 to 3 μm.

6. The field emission backlight unit of claim 1, wherein emitter grooves are formed at predetermined intervals along both edges of the first electrodes, and the emitters are partially exposed by the emitter grooves.

7. The field emission backlight unit of claim 1, wherein the emitters are formed below the first electrodes along both edges of the first electrodes so that the emitters are partially covered by the first electrodes and are partially exposed.

8. A field emission backlight unit, comprising:
a lower substrate;
first and second electrodes alternately formed in parallel lines on the lower substrate;
first emitters interposed between the lower substrate and the first electrodes, and second emitters interposed between the lower substrate and the second electrodes;
an upper substrate spaced a predetermined distance from the lower substrate and facing the lower substrate;
a third electrode formed on a bottom surface of the upper substrate; and
a phosphor layer formed on the third electrode.

9. The field emission backlight unit of claim 8, wherein the first and second emitters are made of carbon nanotubes (CNTs).

10. The field emission backlight unit of claim 8, wherein the first and second electrodes are conductive thick films.

11. The field emission backlight unit of claim 8, wherein each of the first and second electrodes has a thickness in a range of 3 to 30 μm.

12. The field emission backlight unit of claim 8, wherein each of the first and second emitters has a thickness in a range of 1 to 3 μm.

13. The field emission backlight unit of claim 8, wherein emitter grooves are formed at predetermined intervals along both edges of the first and second electrodes, respectively, and the first and second emitters are partially exposed by the respective emitter grooves.

14. The field emission backlight unit of claim 13, wherein the first emitters disposed below the first electrodes and the second emitters disposed below the second electrodes are alternately arranged.

15. The field emission backlight unit of claim 8, wherein the first emitters are formed below the first electrodes along both edges of the first electrodes, and wherein the second emitters are formed below the second electrodes along both edges of the second electrodes, so that the first and second emitters are partially covered by the first and second electrodes, respectively, and are partially exposed.

16. The field emission backlight unit of claim 1, wherein the first electrodes and the second electrodes alternately act as cathodes and gate electrodes, and the third electrode acts as an anode.

17. A method of driving a triode-type field emission backlight unit which includes a lower substrate on which first electrodes, second electrodes and emitters disposed between the first and second electrodes, respectively, are formed, and on which the lower substrate is formed, said triode-type field emission backlight unit further including an upper substrate on which a third electrode is formed, the method comprising the steps of:
applying a cathode voltage to the first electrodes, a gate voltage to the second electrodes, and an anode voltage to the third electrode so as to emit electrons from the emitters disposed between the first electrodes and the lower substrate;
applying a gate voltage to the first electrodes, a cathode voltage to the second electrodes, and an anode voltage to the third electrode so as to emit electrons from the emitters disposed between the second electrodes and the lower substrate; and
repeating the above steps.

18. The method of claim 17, wherein emitter grooves are formed at predetermined intervals along both edges of the first and second electrodes, respectively, and the emitters are partially exposed by the emitter grooves.

19. The method of claim 18, wherein the emitters disposed between the first electrodes and the lower substrate and the emitters disposed between the second electrodes and the lower substrate are alternately arranged.

20. A method of manufacturing a lower panel of a field emission backlight unit, the method comprising the steps of:
forming a patterned CNT layer on a transparent substrate using a screen-printing method;
performing one of drying and firing on the CNT layer;
patterning a conductive thick film in a plurality of parallel lines to form alternating first and second electrodes using a screen-printing method so that the CNT layer is partially covered by both edges of at least the first electrodes; and
drying and firing the conductive thick film.

21. The method of claim 20, wherein the CNT layer is formed in a plurality of parallel lines.

22. The method of claim 21, wherein the plurality of lines are longitudinally arranged at predetermined intervals.

23. The method of claim 20, wherein emitter grooves are formed along both edges of the first electrodes, and the patterned CNT layer is partially covered by the emitter grooves.

24. The method of claim 20, wherein emitter grooves are formed along both edges of the first and second electrodes, and the patterned CNT layer is partially covered by the emitter grooves.
